(19) United States
(12) Patent Application Publication
(10) Pub. No.: US 2026/0063364 A1
(43) Pub. Date: Mar. 5, 2026

(54) AIRFLOW STRUCTURE FOR HAIR GROOMING DEVICE

(71) Applicant: SHENZHEN PETABOO TECHNOLOGY CO., LTD., SHENZHEN (CN)

(72) Inventor: BOCHAO XU, SHENZHEN (CN)

(21) Appl. No.: 19/275,269

(22) Filed: Jul. 21, 2025

(30) Foreign Application Priority Data
Aug. 27, 2024 (CN) 202411184591.2

(51) Int. Cl. F26B 9/00; A01K 13/00; F26B 21/02

(52) U.S. Cl. CPC F26B 9/003; A01K 13/001; F26B 21/20

(57) ABSTRACT

An airflow structure for a hair grooming device is provided, including a host. The host is provided with a first air chamber is on one side, and a second air chamber on the other side. The first air chamber is communicated to the second air chamber by a communication channel arranged therebetween. The first air chamber is provided with an air intake port, the second air chamber is equipped with a suction device, and a first air exhausting port to communicate the second air chamber to the external environment. The air intake port, first air chamber, communication channel, second air chamber, and first air exhausting port are sequentially connected to form a suction airflow path. Above configuration achieves effective noise reduction and improves user experience. Moreover, the suction airflow path spans across the host, allowing full utilization of space, which facilitates the miniaturized design thereof.

### TECHNICAL FIELD

The present disclosure relates to a technical field of pet supplies, and in particular to an airflow structure for a hair grooming device.

### BACKGROUND

Pet hair grooming devices have emerged as innovative products in recent years, designed to trim and remove pet hair while utilizing suction mechanisms for hair collection. However, with continuous product iterations, these devices increasingly prioritize compact and portable designs. This trend results in severely limited internal structural space, making optimal component layout a persistent technical challenge in the field. In related technology, due to the miniaturized design of the hair grooming device, on one hand, it allows the device to be operated closer to the user; on the other hand, the limited structural space of the device makes the noise from the suction unit more prone to propagate outward. As a result, users are exposed to significant noise during operation, adversely affecting the user experience. Moreover, prolonged exposure may even induce noise-related health conditions.

### SUMMARY

In order to overcome shortcomings in the prior art, the present disclosure provides an airflow structure for a hair grooming device including a host.

The technical solution adopted by the present disclosure to overcome the shortcomings in the prior art is:

The present disclosure provides the airflow structure for a hair grooming device, including a host. A first air chamber is configured on one side of the host, a second air chamber is configured on the other side of the host. A communication channel is arranged between the first air chamber and the second air chamber, to communicate the first air chamber with the second air chamber. The first air chamber is provided with an air intake port. The second air chamber is equipped with a suction device. The second air chamber is further provided with a first air exhausting port to communicate the second air chamber to the external environment. The air intake port, the first air chamber,the communication channel, the second air chamber, and the first air exhausting port are sequentially connected to form a suction airflow path.

The first air chamber and the second air chamber are arranged opposite to each other, a circulation space is formed between the first air chamber and the second air chamber, a channel component is disposed between the first air chamber and the second air chamber, the communication channel is provided within the channel component, one end of the channel component is connected to a central portion of the first air chamber, and the other end of the channel component is connected to a central portion of the second air chamber, such that the circulation space surrounds the channel component.

The channel component is further provided with an air intake passage inside, one end of the air intake passage is connected to the air intake port of the first air chamber, the other end of the air intake passage forms a communicating port, and the communicating port is exposed to the circulation space.

The airflow structure for a hair grooming device further includes an air duct hose. The air duct hose is connected to the communicating port, the air duct hose is arranged within the circulation space and coiling the channel component, and the first air chamber and the second air chamber clamp the air duct hose from both sides respectively.

The first air chamber is provided with a first communication port, one end of the communication channel is connected to the first communication port, and the air intake port is arranged offset from the first communication port.

The first air chamber is internally provided with a wind guide plate, wherein one end of the wind guide plate is connected to an inner wall of the first air chamber, the other end of the wind guide plate is a free end for shielding the air intake port, a circulation gap is formed by maintaining a spacing between the free end of the wind guide plate and the inner wall of the first air chamber, and the circulation gap is not oriented toward the first communication port.

The first communication port is provided with a filtering device, the filtering device is configured to filter airflow flowing from the first air chamber to the communication channel, and the first air chamber function as a hair collection cavity.

The second air chamber is provided with a second communication port, the other end of the communication channel is connected to the second communication port, the suction device in the second air chamber is disposed at the second communication port, the first air exhausting port is arranged offset from the second communication port, and thereby the second air chamber function as a heat dissipation cavity.

The airflow structure for a hair grooming device further includes locking screws. An inner wall of the second air chamber is provided with a plurality of mounting posts, the plurality of mounting posts are arranged around the second communication port, each mounting post is provided with a mounting threaded hole, the suction device is correspondingly provided with a mounting ring, the mounting ring is provided with a plurality of mounting through holes, the mounting ring is sleeved on the mounting posts via the mounting through holes, a vibration damping sleeve is arranged between each mounting post and the corresponding mounting through hole, and the locking screws are threaded into the mounting threaded holes to lock and fix the mounting ring to the mounting posts.

The airflow structure for a hair grooming device further includes a cover body. The cover body encloses the suction device, the cover body is provided with a second air exhausting port, the second air exhausting port being arranged facing one side of the cover body, the first air exhausting port is located on the other side of the cover body, and the first air exhausting port is formed on a side wall of the second air chamber and faces the circulation space.

The beneficial effects of the present disclosure are as follows. Through the aforementioned structural arrangement, the air intake port, the first air chamber, the communication channel, the second air chamber, and the first air exhausting port are sequentially connected to form a suction airflow path. During operation, under the suction effect of the suction device, external airflow sequentially passes through each structural component of the suction airflow path, thereby extending the flow path of the airflow. That is, the propagation path of noise to the external environment is extended. This configuration can provide certain noise filtration and absorption effects, achieving effective noise reduction and improving user experience. Moreover, in the above structure, the suction airflow path spans across the host of the hair grooming device, allowing full utilization of the limited space within the hair grooming device, which facilitates the miniaturized design of the hair grooming device.

### BRIEF DESCRIPTION OF DRAWINGS

In order to more clearly illustrate embodiments of the present disclosure or technical solutions in the prior art, accompanying drawings required in the embodiments or the prior art are briefly introduced below, and obviously, the accompanying drawings in following description are merely some embodiments of the present disclosure, and for those who skilled in the art, other drawings may also be obtained according to structures shown in the accompanying drawings without creative efforts.

FIG. 1 is a structural schematic diagram at a first angle according to an exemplary embodiment of the present disclosure.

FIG. 2 is a structural schematic diagram at a second angle according to an exemplary embodiment of the present disclosure..

FIG. 3 is a schematic diagram showing the communicating port according to an exemplary embodiment of the present disclosure.

FIG. 4 is a schematic diagram showing the coiled air duct hose according to an exemplary embodiment of the present disclosure.

FIG. 5 is an exploded view of the first air chamber according to an exemplary embodiment of the present disclosure.

FIG. 6 is an exploded view of the first air chamber according to an exemplary embodiment of the present disclosure, wherein the filtering device is also exploded.

FIG. 7 is an enlarged view of portion A in FIG. 6.

FIG. 8 is a cross-sectional schematic diagram along the communication channel according to an exemplary embodiment of the present disclosure, wherein the second air chamber is exploded.

FIG. 9 is an exploded view of the second air chamber according to an exemplary embodiment of the present disclosure.

FIG. 10 is an exploded view of the second air chamber according to an exemplary embodiment of the present disclosure, wherein the cover body is also exploded.

FIG. 11 is an enlarged view of portion B in FIG. 8.

FIG. 12 is a schematic diagram showing the first exhaust port according to an exemplary embodiment of the present disclosure.

### DETAILED DESCRIPTION OF EMBODIMENTS

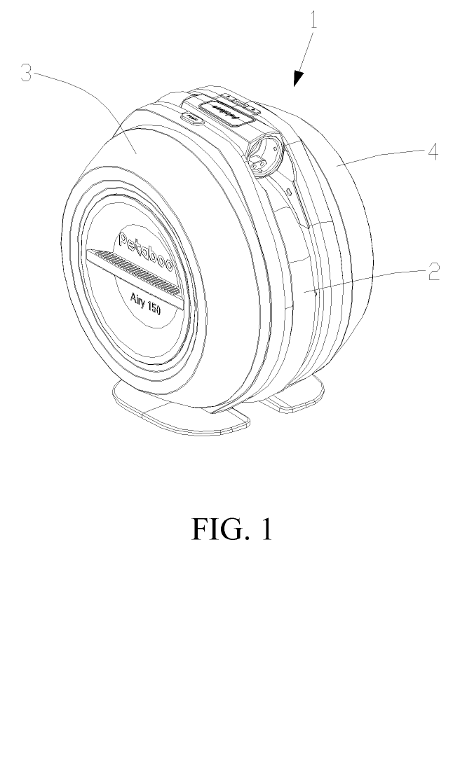

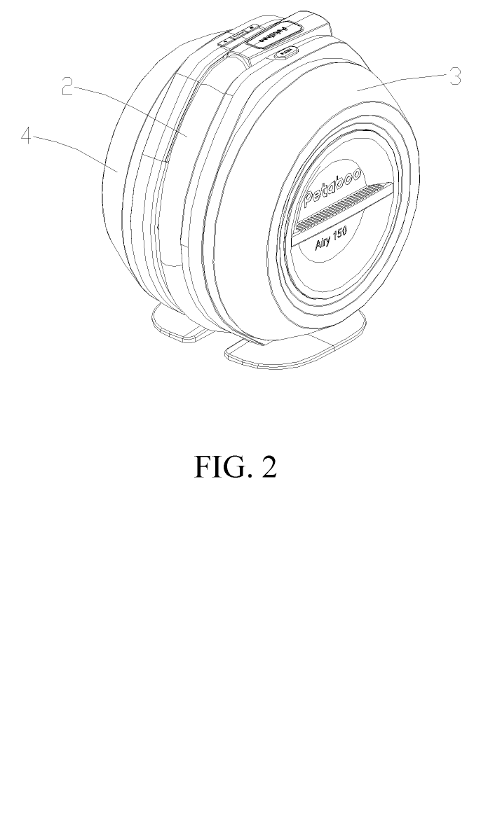

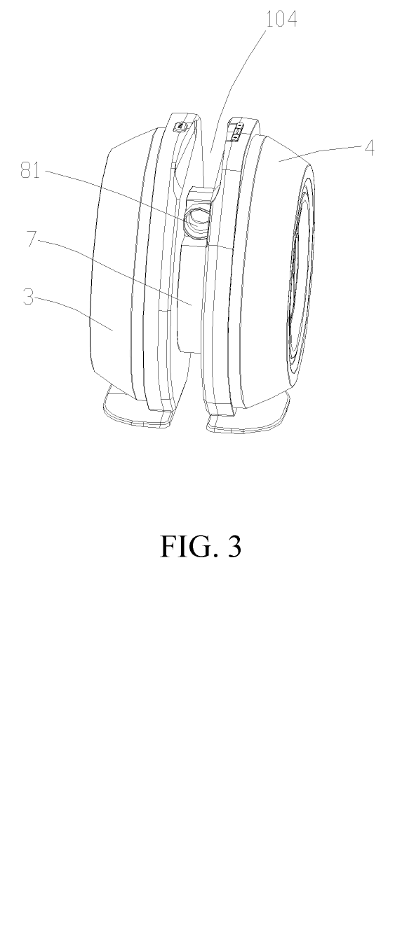

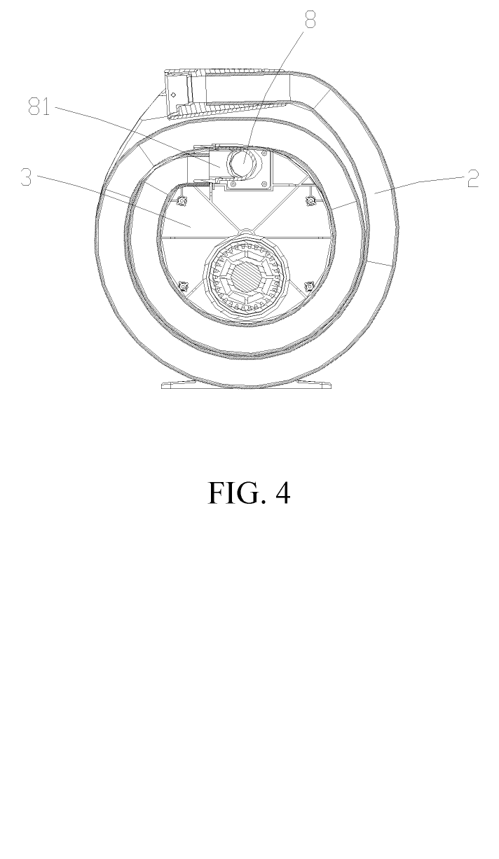

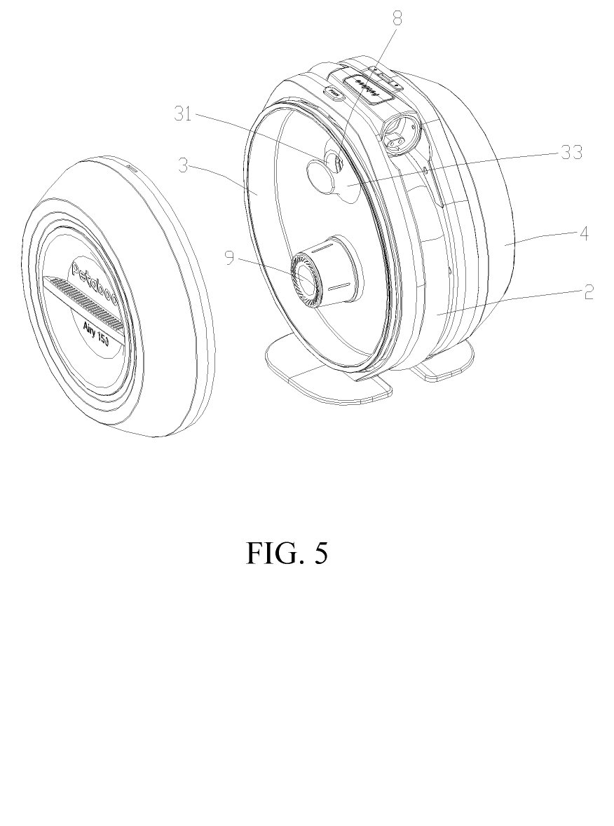

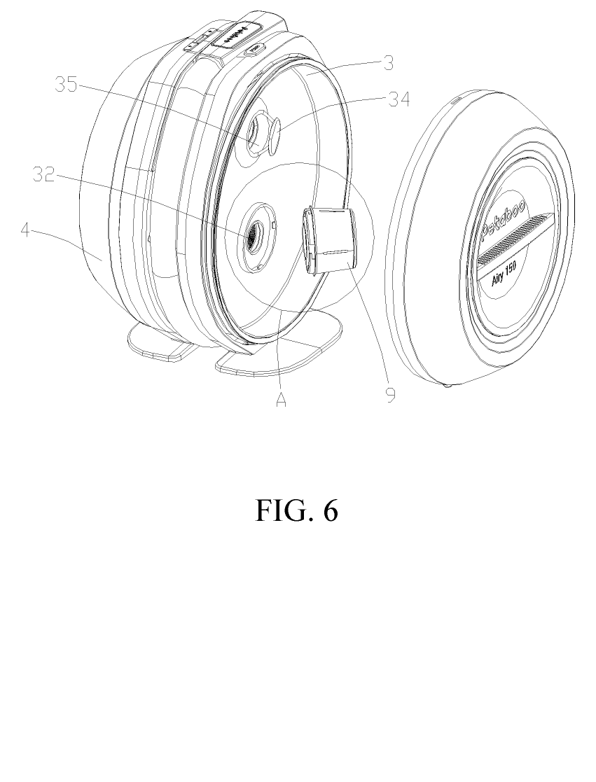

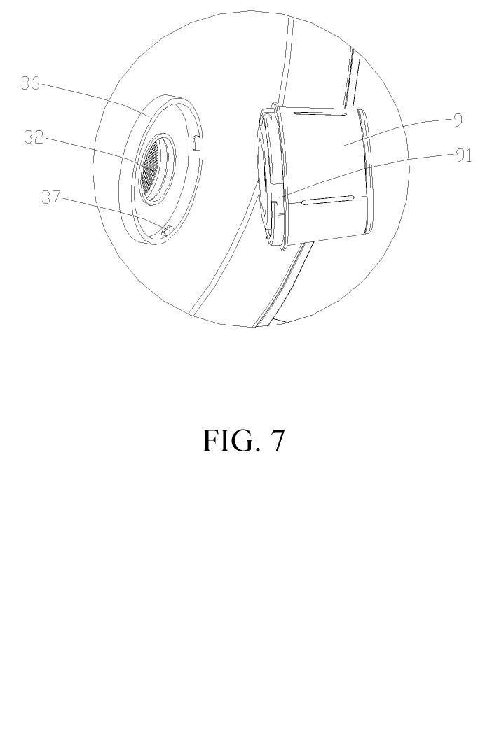

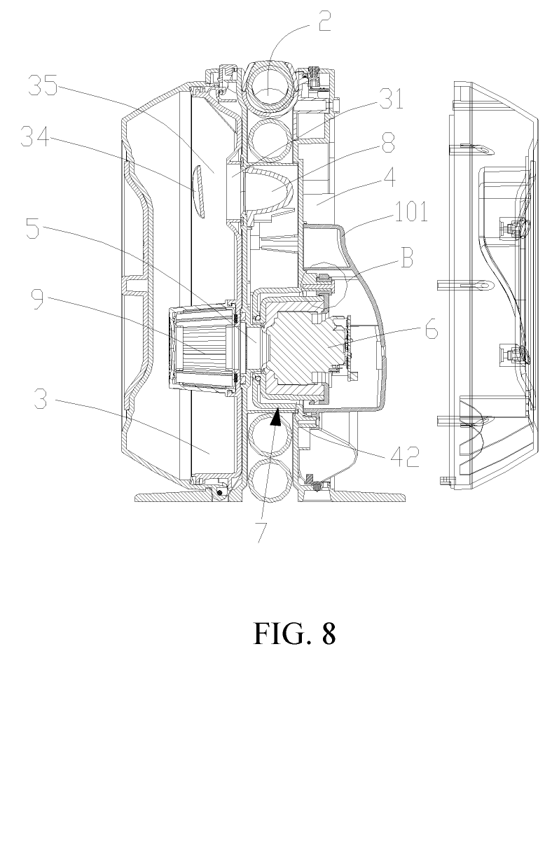

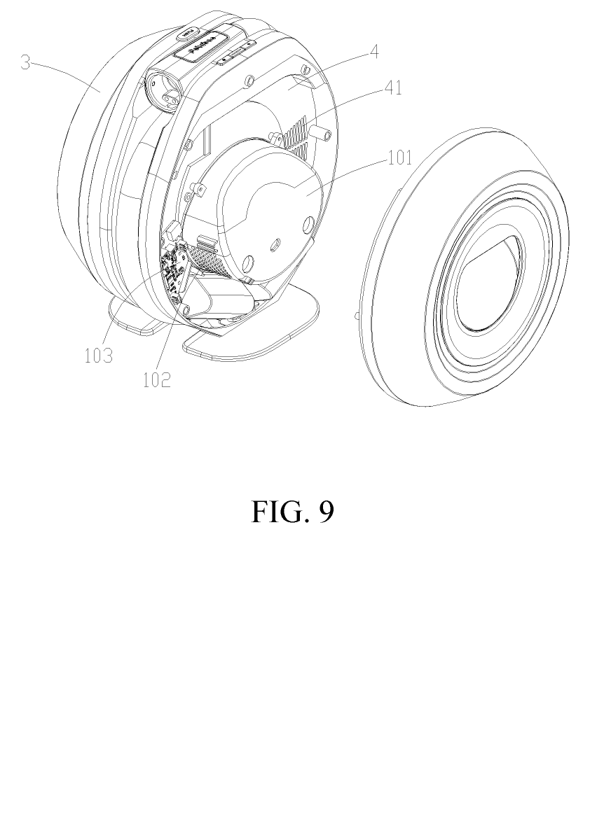

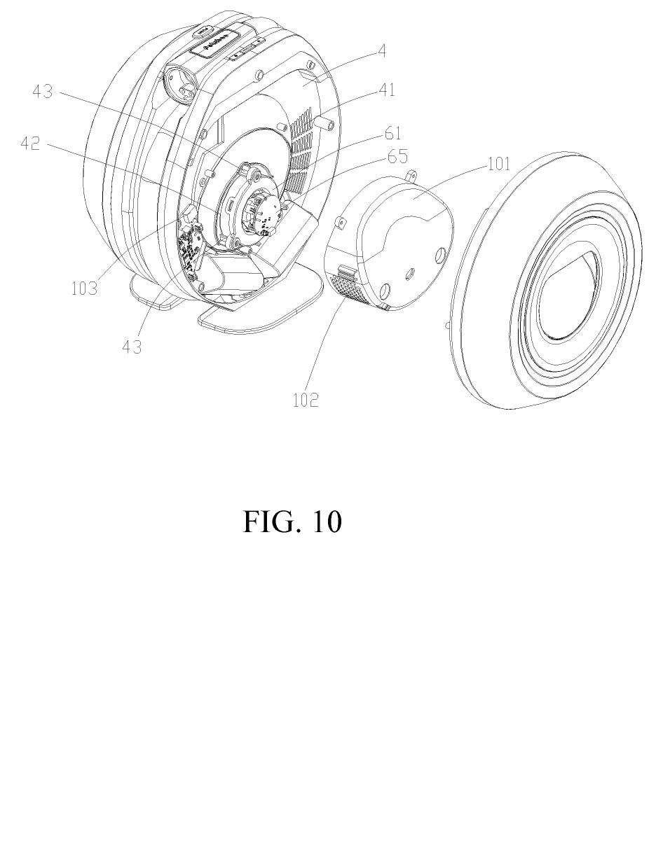

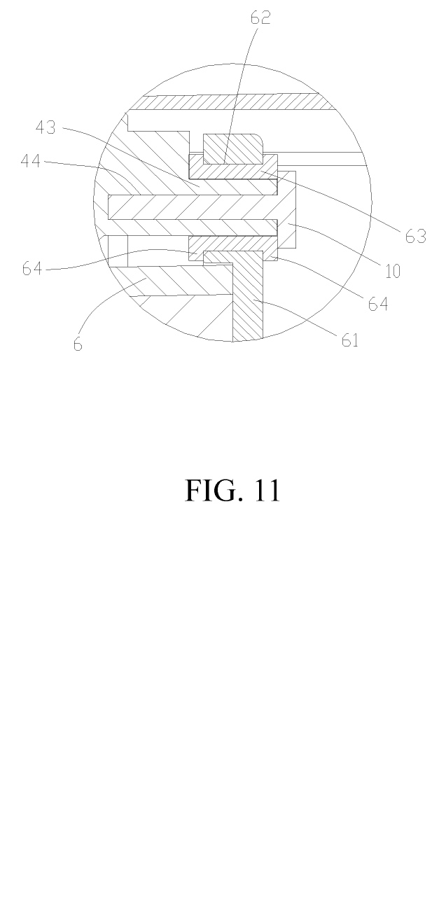

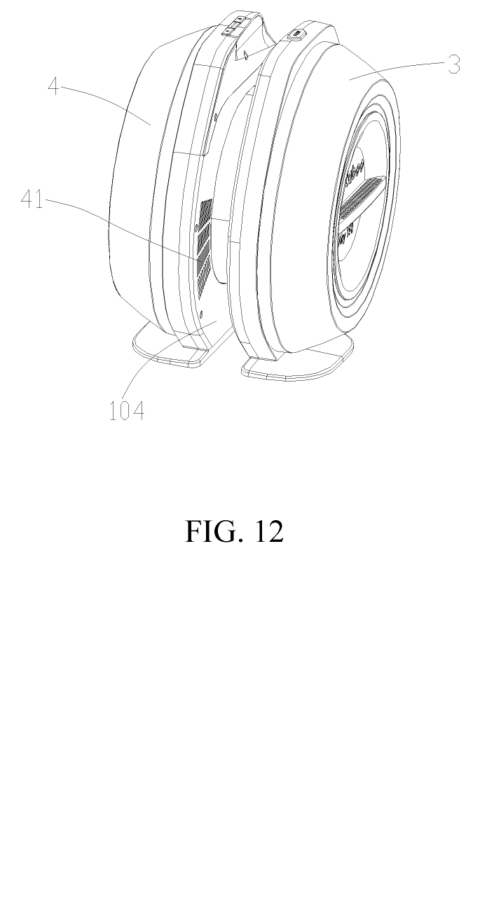

Referring to FIGS. 1 to 12, an airflow structure for a hair grooming device includes a host 1. A first air chamber 3 is configured on one side of the host 1, and a second air chamber 4 is configured on the other side of the host 1. A communication channel 5 is arranged between the first air chamber 3 and the second air chamber 4 to communicate the first air chamber 3 with the second air chamber 4. The first air chamber 3 is provided with an air intake port 31, and the second air chamber 4 is equipped with a suction device 6. The second air chamber 4 is further provided with a first air exhausting port 41 to allow the second air chamber 4 to communicate with the external environment. The air intake port 31, the first air chamber 3, the communication channel 5, the second air chamber 4, and the first air exhausting port 41 are sequentially connected to form a suction airflow path.

Through the aforementioned structural arrangement, the air intake port 31, the first air chamber 3, the communication channel 5, the second air chamber 4, and the first air exhausting port 41 are sequentially connected to form a suction airflow path. During operation, under the suction effect of the suction device 6, external airflow sequentially passes through each structural component of the suction airflow path, thereby extending the flow path of the airflow. That is, the propagation path of noise to the external environment is extended. This configuration can provide certain noise filtration and absorption effects, achieving effective noise reduction and improving user experience. Moreover, in the above structure, the suction airflow path spans across the host 1 of the hair grooming device, allowing full utilization of the limited space within the hair grooming device, which facilitates the miniaturized design of the hair grooming device.

In an exemplary embodiment, the first air chamber 3 and the second air chamber 4 are arranged opposite to each other, thereby forming a circulation space 104 between the first air chamber 3 and the second air chamber 4. A channel component 7 is disposed between the first air chamber 3 and the second air chamber 4. The communication channel 5 is provided within the channel component 7. One end of the channel component 7 is connected to a central portion of the first air chamber 3, and the other end of the channel component 7 is connected to a central portion of the second air chamber 4, such that the circulation space 104 surrounds the channel component 7. Through the above structural arrangement, the first air chamber 3 and the second air chamber 4 are distributed on opposite sides and connected via the channel component 7 (communication channel). Moreover, the presence of the circulation space 104 further enhances heat dissipation for the first air chamber 3, the second air chamber 4, and the channel component 7, resulting in a more rational structural layout of the hair grooming device. In some embodiment, a first portion of the channel component 7 may be integrally formed with the first air chamber 3, and a second portion of the channel component 7 may be integrally formed with the second air chamber 4, wherein the first portion and the second portion are joined to form a complete channel component 7. It should be noted that the specific configuration of the channel component 7 is not absolutely limited and is provided merely as an exemplary embodiment of the present disclosure.

In an exemplary embodiment, an air intake passage 8 is further disposed within the channel component 7. One end of the air intake passage 8 is connected to the air intake port 31 of the first air chamber 3, the other end of the air intake passage 8 forms a communicating port 81, and the communication port 81 is exposed to the circulation space 104. Specifically, the air intake passage 8 is a curved passage, which has a simple structure and a rational design.

Furthermore, the airflow structure further includes a air duct hose 2. The air duct hose 2 is connected to the communication port 81 and arranged within the circulation space 104 while coiling the channel component 7. The first air chamber 3 and the second air chamber 4 clamp the air duct hose 2 from both sides respectively. Through this structural arrangement, the communication port 81 can be formed on the channel component 7, thereby allowing the air duct hose 2 to connect to the circulation space 104. On one hand, this enables the air duct hose 2 to be coiled around the channel component 7 for compact storage, making full use of the structural space of the hair grooming device with ingenious design. On the other hand, the air duct hose 2 is arranged within the circulation space 104, thereby facilitating heat dissipation of the air duct hose 2.

In an exemplary embodiment, the first air chamber 3 is provided with a first communication port 32. One end of the communication channel 5 is connected to the first communication port 32, while the air intake port 31 and the first communication port 32 are offset from each other. This ensures that the airflow entering the first air chamber 3 through the air intake port 31 does not directly flow into the first communication port 32, thereby extending the airflow path (i.e., the noise propagation path to the external environment is extended) and further enhancing noise reduction effect.

Furthermore, the first air chamber 3 is internally provided with a wind guide plate 33. That is, the wind guide plate 33 is disposed within the first air chamber 3. One end of the wind guide plate 33 is connected to an inner wall of the first air chamber 3, while the other end is a free end 34 configured to shield the air intake port 31. A spacing is formed between the free end 34 and the inner wall of the first air chamber 3, thereby defining a circulation gap 35. The circulation gap 35 is not oriented toward the first communication port 32. This arrangement ensures that the airflow circulates maximally within the first air chamber 3, thereby extending the airflow path and further enhancing noise reduction.

In an exemplary embodiment, the first communication port 32 is provided with a filter device 9, to filter airflow flowing from the first air chamber (3) to the communication channel 5, thereby enabling the first air chamber (3) to function as a hair collection cavity. The filter device effectively traps pet hair and debris within the first air chamber 3, facilitating cleaning of the hair grooming device. Specifically, the first air chamber 3 is detachable from the host 1 for easier debris removal. The detachment mechanism may employ snap-fit fasteners or similar structures, though the specific design is not limited herein. Additionally, this configuration prevents debris from entering the first communication port 32 (i.e., prevents debris from entering the suction device 6), thereby protecting the suction device 6 and improving the overall design rationality of the hair grooming device.

In another exemplary embodiment, the filter device 9 is also detachable. Specifically, the inner wall of the first air chamber 3 is provided with an annular mounting protrusion 36 surrounding the first communication port 32. An inner wall of the mounting protrusion 36 is equipped with snap-fit fasteners 37, while an outer wall of the filter device 9 features L-shaped slots 91. The filter device 9 is secured by engaging its L-shaped slots 91 with the snap-fit fasteners 37 on the mounting protrusion 36, enabling removable installation of the filter device 9 at the first communication port 32. The structure is simple, facilitating disassembly and cleaning. Further, the filter device 9 may include a multi-layer structure: a primary mesh filter, a secondary sponge filter, and a tertiary filter cartridge, ensuring effective capture of pet hair and fine debris.

In an exemplary embodiment, the second air chamber 4 is provided with a second communication port 42. The other end of the communication channel 5 is connected to the second communication port 42, and the suction device 6 in the second air chamber 4 is disposed at the second communication port 42. The first air exhausting port 41 and the second communication port 42 are offset from each other, thereby configuring the second air chamber 4 function as a heat dissipation cavity. This arrangement ensures that airflow entering the second air chamber 4 via the communication channel 5 does not directly flow to the first air exhausting port 41, thereby extending the airflow path (i.e., extending the noise propagation path to the external environment) and further enhancing noise reduction.

In an exemplary embodiment, the airflow structure further includes locking screws 10. An inner wall of the second air chamber 4 is provided with a plurality of mounting posts 43 arranged around the second communication port 42. Each mounting post 43 has a mounting threaded hole 44. Correspondingly, the suction device 6 is provided with a mounting ring 61 featuring multiple mounting through-holes 62. The mounting ring 61 is sleeved on the mounting posts 43 via the mounting through-holes 62, with vibration-damping sleeves 63 interposed between the mounting posts 43 and the mounting through-holes 62. The locking screws 10 are threaded into the mounting threaded holes 44 to secure the mounting ring 61 to the mounting posts 43. This structural configuration allows the suction device 6 to be installed within the second air chamber 4 and inserted into the second communication port 42, optimizing suction efficiency of the suction device 6 and improving structural rationality. Both ends of each vibration-damping sleeve 63 extend to form covering portions 64 that respectively envelop two sides of the mounting ring 61, further enhancing vibration absorption. The suction device 6 may specifically be a suction motor, and its control circuit board 65 can be positioned at the motor's rear end within the suction airflow path to facilitate heat dissipation, which has a simple structure and a rational design.

In an exemplary embodiment, the airflow structure further includes a cover body 101 enclosing the suction device 6. The cover body 101 is provided with a second air exhausting port 102. The second air exhausting port 102 being arranged facing one side of the cover body 101, the first air exhausting port 41 is located on the other side of the cover body 101. Through the above structural configuration, on one hand, by enclosing the suction device 6 with the cover body 101, noise generated by the suction device 6 can be reduced. Further, with the arrangement of the second air exhausting port 102, normal airflow and effective heat dissipation for the suction device 6 are achieved. Meanwhile, since the second air exhausting port 102 is oriented toward one side of the cover 101 while the first air exhausting port 41 is located on the opposite side of the cover 101, the airflow can flow more extensively within the second air chamber 4. That is, the airflow path is extended, thereby further enhancing the noise suppression effect. Additionally, electronic components 103 of the hair grooming device may be disposed at the second air exhausting port 102 inside the second air chamber 4, which effectively dissipates heat from these electronic components 103 and fully realizes the function of the second air chamber 4 as a heat dissipation cavity.

Moreover, the first air exhausting port 41 is formed on a sidewall of the second air chamber 4 and faces the circulation space 104. Thus, airflow passing through the suction airflow path can be discharged into the circulation space 104 via the first air exhausting port 41, further promoting airflow movement within the circulation space 104, thereby enhancing heat dissipation efficiency.

In summary, in the airflow structure of the pet grooming device according to the present disclosure, the air duct hose 2, the communicating port 81, the air intake passage 8, the air intake port 31, the circulation gap 35, the first air chamber 3, the first communication port 32, the communication channel 5, the second communication port 42, the cover body 101, the second air exhausting port 102, the second air chamber 4, and the first air exhausting port 41 are sequentially connected to form a suction airflow path. Specifically, the suction airflow path originates from the circulation space 104 (at the communicating port 81) and terminates in the circulation space 104 (at the first air exhausting port 41), achieving a dual-span layout across both sides of the host 1 of the hair grooming device; combined with components such as the wind guide plate 33 and cover body 101, this design enables a rational and efficient layout within the limited structural space of the hair grooming device, effectively elongating both the intake and exhaust sections of the suction airflow path while increasing tortuosity of the suction airflow path, thereby providing excellent noise suppression. This configuration also facilitates miniaturization of the hair grooming device; simultaneously, based on the suction airflow path design, it integrates hair collection, storage of the air duct hose 2, and heat dissipation functions, resulting in a rational and ingenious design.

The above are only preferred embodiments of the present disclosure and are not intended to limit the present disclosure, and any modification, equivalent replacement and improvement made within a spirit and a principle of the present disclosure shall fall within a protection scope of the present disclosure.

What is claimed is:

1. An airflow structure for a hair grooming device, comprising a host, wherein,
a first air chamber is configured on one side of the host, a second air chamber is configured on the other side of the host,
a communication channel is arranged between the first air chamber and the second air chamber, to communicate the first air chamber with the second air chamber,
the first air chamber is provided with an air intake port, the second air chamber is equipped with a suction device, the second air chamber is further provided with a first air exhausting port to communicate the second air chamber to the external environment, and
the air intake port, the first air chamber, the communication channel, the second air chamber, and the first air exhausting port are sequentially connected to form a suction airflow path.

2. The airflow structure for a hair grooming device according to claim 1, wherein the first air chamber and the second air chamber are arranged opposite to each other, a circulation space is formed between the first air chamber and the second air chamber, a channel component is disposed between the first air chamber and the second air chamber, the communication channel is provided within the channel component, one end of the channel component is connected to a central portion of the first air chamber, and the other end of the channel component is connected to a central portion of the second air chamber, such that the circulation space surrounds the channel component.

3. The airflow structure for a hair grooming device according to claim 2, wherein the channel component is further provided with an air intake passage inside, one end of the air intake passage is connected to the air intake port of the first air chamber, the other end of the air intake passage forms a communicating port, and the communicating port is exposed to the circulation space.

4. The airflow structure for a hair grooming device according to claim 3, further comprising an air duct hose, wherein the air duct hose is connected to the communicating port, the air duct hose is arranged within the circulation space and coiling the channel component, and the first air chamber and the second air chamber clamp the air duct hose from both sides respectively.

5. The airflow structure for a hair grooming device according to claim 2, wherein the first air chamber is provided with a first communication port, one end of the communication channel is connected to the first communication port, and the air intake port is arranged offset from the first communication port.

6. The airflow structure for a hair grooming device according to claim 5, wherein the first air chamber is internally provided with a wind guide plate, wherein one end of the wind guide plate is connected to an inner wall of the first air chamber, the other end of the wind guide plate is a free end for shielding the air intake port, a circulation gap is formed by maintaining a spacing between the free end of the wind guide plate and the inner wall of the first air chamber, and the circulation gap is not oriented toward the first communication port.

7. The airflow structure for a hair grooming device according to claim 5, wherein the first communication port is provided with a filtering device, the filtering device is configured to filter airflow flowing from the first air chamber to the communication channel, and the first air chamber function as a hair collection cavity.

8. The airflow structure for a hair grooming device according to claim 5, wherein the second air chamber is provided with a second communication port, the other end of the communication channel is connected to the second communication port, the suction device in the second air chamber is disposed at the second communication port, the first air exhausting port is arranged offset from the second communication port, and thereby the second air chamber function as a heat dissipation cavity.

9. The airflow structure for a hair grooming device according to claim 8, further comprising locking screws, wherein an inner wall of the second air chamber is provided with a plurality of mounting posts, the plurality of mounting posts are arranged around the second communication port, each mounting post is provided with a mounting threaded hole, the suction device is correspondingly provided with a mounting ring, the mounting ring is provided with a plurality of mounting through holes, the mounting ring is sleeved on the mounting posts via the mounting through holes, a vibration damping sleeve is arranged between each mounting post and the corresponding mounting through hole, and the locking screws are threaded into the mounting threaded holes to lock and fix the mounting ring to the mounting posts.

10. The airflow structure for a hair grooming device according to claim 8, further comprising a cover body, wherein the cover body encloses the suction device, the cover body is provided with a second air exhausting port, the second air exhausting port being arranged facing one side of the cover body, the first air exhausting port is located on the other side of the cover body, and the first air exhausting port is formed on a side wall of the second air chamber and faces the circulation space.
